(19) United States
(12) Patent Application Publication
(10) Pub. No.: US 2007/0107042 A1
(43) Pub. Date: May 10, 2007

(54) System and method for limiting access to a shared multi-functional peripheral device

(76) Inventor: Fatima Corona, Long Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/266,782

(22) Filed: Nov. 4, 2005

(51) Int. Cl. H04L 9/32

(52) U.S. Cl. 726/2

(57) ABSTRACT

A system and method for providing selective access to the functions of a multi-function peripheral device are disclosed. The system includes a portable memory device storing user data; a reader configured to read the user data from the portable memory device; an authenticating device in data communication with the reader, the authenticating device configured to receive the user data from the reader and to authenticate a user based on the user data, thereby creating authenticating information; and a multi-function printer (MFP) in data communication with the authenticating device via a network. The multi-function printer is configured to receive the authenticating information from the authenticating device and to provide selective access to operations according to the authenticating information.

### CROSS-REFERENCE TO RELATED APPLICATIONS

This application is related to U.S. patent application Ser. No.______, filed concurrently herewith (Attorney Docket No. SAMINF.018A) and entitled “SYSTEM AND METHOD FOR LIMITING ACCESS TO A SHARED MULTI-FUNCTIONAL PERIPHERAL DEVICE BASED ON PRESET USER PRIVILEGES,” which is hereby incorporated by reference herein.

### BACKGROUND OF THE INVENTION

1. Field of the Invention

The invention relates to the security of shared office machines. More particularly, the invention relates to limiting access to shared office machines only to authorized users.

2. Description of the Related Technology

Recently, many office machines are shared by multiple users. These office machines may be accessed by these users through a computer network or in person. For various reasons, there is a need to limit access to these shared office machines only to authorized users.

### SUMMARY OF CERTAIN INVENTIVE ASPECTS

One aspect of the invention provides a system for limiting access to a multi-function printer. The system comprises a portable memory device storing user data; a reader configured to read the user data from the portable memory; an authenticating device in data communication with the reader, the authenticating device configured to receive the user data from the reader and to authenticate a user based on the user data, thereby creating authenticating information; and a multi-function printer (MFP) in data communication with the authenticating device via a network, the multi-function printer configured to receive the authenticating information from the authenticating device and to provide selective access to operations according to the authenticating information.

In the above-described system, the MFP may be connected to the reader and the MFP may be configured to receive the user data from the reader and to transmit the user data to the authenticating device. The user data may be encrypted and the MFP may receive and transmit the encrypted user data intact. The reader may be in data communication with the authenticating device via a computer. Alternatively, the reader may be connected to the authenticating device via a network. The portable memory device may comprise a smart card. The MFP functions may comprise a printer, a scanner, a photocopier, and a facsimile machine. The authenticating device may comprise a computer configured to execute user authenticating software. The user data may be encrypted. The authenticating device may comprise a data storage configured to store a user profile for each one of a plurality of users. The authenticating device may be configured to authenticate the user based on the user data and the user profile. The user profile may comprise at least one of access restriction and privilege of the user. The MFP may be configured to receive a password from the user and to transmit the password to the authenticating device. In addition, the MFP may be configured to encrypt the password received from the user, and the authenticating device may be configured to decrypt the encrypted password before authenticating the user.

Another aspect of the invention provides a system for limiting access to a multi-function printer comprising means for storing user data; means for receiving the user data from the means for storing user data; authenticating means for determining whether a user identified with the user data is authorized for a requested operation, thereby creating authenticating information indicative of the determination; and means for multi-function operation, the multi-function operation means processing the requested operation according to the authenticating information. The means for storing user data may be accessible using a USB port of a computer, and the means for receiving the user data may comprise a computer having a USB port.

Yet another aspect of the invention provides a method of providing selective access to a multi-function peripheral device. The method comprises reading user data from a portable memory device; transmitting the user data to an authenticating device; determining whether a user identified by the user data is authorized to use the multi-function peripheral device, thereby creating authenticating information; and transmitting the authenticating information to the peripheral device so that each functional operation of the multi-function peripheral device can be selectively accessed according to the authenticating information.

In the above-described method, the user data may be transmitted to the authenticating device via the peripheral device or a computer. Alternatively, the user data may be transmitted to the authenticating device via a network. The authenticating information may include at least one of access restriction and privilege of the user the user data may be stored encrypted in the portable memory device, and the encrypted user data may be decrypted before determining whether the user identified by the user data is authorized to use a peripheral device.

The above-described method may further comprise receiving a password from a user; and transmitting the password to the authenticating device. The method may further comprise encrypting the password prior to transmitting the password to the authenticating device; decrypting the encrypted password prior to determining; and using the password in determining. In addition, the method may comprise operating the peripheral device according to the selective access provided to the user. The method may further comprise encrypting the authenticating information prior to transmitting to the peripheral device; and decrypting the authenticating information subsequent to transmitting the authenticating information to the peripheral device.

### BRIEF DESCRIPTION OF THE DRAWINGS

FIG. 1 schematically illustrates a system for limiting access to a shared office machine according to an embodiment of the invention.

FIG. 2 is a flowchart for a setup of the system of FIG. 1 according to one embodiment of the invention.

FIG. 3 is a flowchart of a method for limiting access to a shared office machine according to an embodiment of the invention.

FIG. 4 is a flowchart of receiving and forwarding encrypted data according to an embodiment of the invention.

FIG. 5 is a flowchart of authenticating a user according to an embodiment of the invention.

FIG. 6 is a flowchart of operating a shared office machine pursuant to authenticating information according to an embodiment of the invention.

FIG. 7 schematically illustrates a system for limiting access to a shared office machine according to another embodiment of the invention.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements.

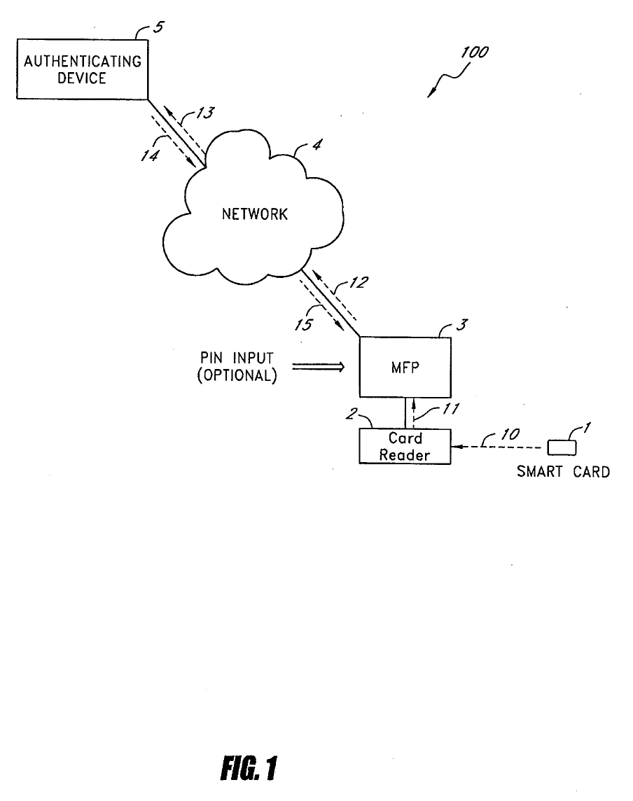

FIG. 1 illustrates a system 100 that can be used in limiting access to an office machine according to an embodiment of the invention. Illustrated are a smart card 1, a smart card reader 2, a multi-functional peripheral device (MFP) 3, a network 4, and an authenticating device 5. The smart card reader 2 is connected to the MFP 3, which is connected to the authenticating device 5 via the network 4.

In the illustrated embodiment, a user needs a smart card 1 containing user identifying information to use the MFP 3. When requesting an operation of the MFP 3, the user lets the card reader 2 read the user identifying information from the smart card 1. The card reader 2 transmits the user identifying information to the authentication device through the MFP 3 and network 4 (dashed arrows 11, 12 and 13). In the embodiment, the MFP 3 does not process the user identifying information. The authenticating device 5 receives the user identifying information and determines whether the user is authorized to use the MFP 3 using the user identifying information and pre-stored data about the user (user profile). The authenticating device 5 then transmits a result of the determination to the MFP 3 (dashed arrows 14 and 15). The MFP 3 receives the result and processes the user's operation request according to the result.

The smart card 1 is a portable device having a memory storage capability. In the illustrated embodiment, the smart card 1 contains user data such as a username in its memory. Although not limited thereto, the smart card 1 is typically a credit card shaped card. In one embodiment, the smart card 1 includes an embedded processor and a memory. The processor may manage data storage in its memory and/or data transfer with another device such as a card reader. The memory of the smart card 1 can be of any suitable type that can be embedded in or on a smart card, and can be writable and/or readable electronically, magnetically, or optically. In another embodiment, the smart card 1 is a memory card containing only memory components. In yet another embodiment, the smart card 1 is a portable memory device such as a memory chip, which is accessible using a universal serial bus (USB) port. In another embodiment, the smart card 1 is a magnetic stripe card.

The card reader 2 is a device that can read data stored in the memory of the smart card 1. In one embodiment, the card reader 2 has a mechanism that matches the type of the memory of the smart card 1. For example, if the smart card 1 has a magnetically readable memory, the card reader 2 has a head to read the data stored in the magnetically readable memory. In another embodiment, the card reader 2 has more than one mechanism to read data from more than one form of memory of the smart card 1. In another embodiment, the card reader 2 may receive data via data communication with the smart card 1 rather than a direct memory read operation. For example, the smart card 1 having an embedded processor may transfer data stored in its memory to the card reader 2 via a communications protocol.

The card reader 2 is connected to the MFP 3. In another embodiment, the card reader 2 can be directly connected to the network 4 or the authenticating device 5, thus bypassing the MFP 3. In one embodiment, the card reader 2 is connected to the MFP 3 or authenticating device 5 via a wired connection such as a USB cable. Alternatively, the card reader 2 can be connected to the MFP 3 via a wireless communication link. In the illustrated embodiment, the smart card reader 2 transmits user data read from the smart card 1 to the MFP 3 (arrow 11).

The MFP 3 is an office machine that can be shared by multiple users. Although connected to a network in FIG. 1, the MFP 3 may be accessed directly by a user without network connection. Although referred to as a multi-functional peripheral device, the MFP 3 can be a printer, scanner, facsimile machine or photocopier and generally has a printing functionality. In one embodiment, the MFP 3 is an office machine having two or more functions of printing, scanning, facsimile receiving and transmitting, and photocopying.

The MFP 3 has a processor to control its operation. In an embodiment, the processor of the MFP 3 controls and manages its operation according to information received from the authenticating device. In addition, the MFP 3 has a memory to at least temporarily store data received from other devices.

Optionally, the MFP 3 may have an input device to receive security input data from a user. The security input data can be of any suitable type, such as a password, fingerprint, voice, and iris pattern of the user. In one embodiment, the input device used to receive the security input data is an integral part of the MFP 3, for example, a keypad integrated in the MFP 3. In another embodiment, the input device is an external device connected to the MFP 3. The input device may be configured to receive a selected form of input such as text, sounds, images, etc. This feature can provide more security than receiving only the user data from the smart card 1. However, in other embodiments, the user data and security data may be the same. For instance, the user may place a finger on a fingerprint reader and the received image or set of data points indicative of the fingerprint can be compared to prestored identification data for the user. The user identification data can be stored in a database along with use limitations associated with the MFP, which is accessed by the authentication device 5. In an embodiment, the security input data is encrypted using an encryption method. In one embodiment, the encryption method for encrypting the security input data is different from that for the user data stored in the smart card 1.

The network 4 interconnecting the MFP 3 and authenticating device 5 can be any suitable form of information network interconnecting various computers, computerized devices and network devices. The network 4 may have either or both wired and wireless connections. The network may be a local area network (LAN), wide area network (WAN), or the Internet. Further, in an embodiment, the network 4 may be a dedicated communication path between the MFP 3 and authenticating device 5.

The authenticating device 5 is generally any general purpose computer or dedicated device that is configured to perform authentication of a user using user data from the smart card 1. In one embodiment, the authenticating device 5 contains a user authenticating software program, which manages and controls a database of user profiles. In the illustrated embodiment, the authenticating device 5 is located remotely from the MFP 3. In other embodiments, the authenticating device 5 can be located in the vicinity of the MFP 3. In an embodiment, the authenticating device 5 is separate and independent from the MFP 3 such that they are in data communication with each other.

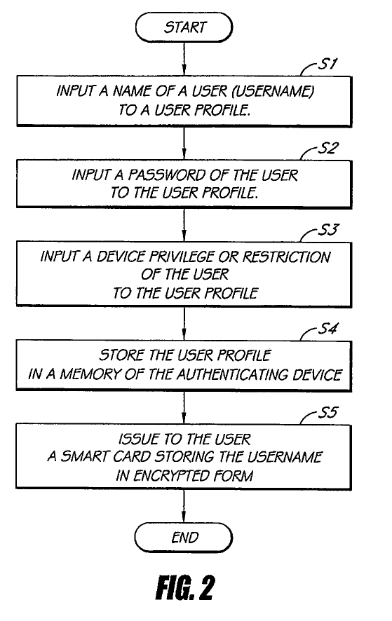

As noted above, the user data is stored in the smart card 1. The user data may be stored in an encrypted form or non-encrypted form. In one embodiment to be described with reference to FIG. 2, the user data is in an encrypted form. The user data may be encrypted using an encryption method known in the industry such as those disclosed in the Federal Information Processing Standards FIPS No. 140-2 Security Requirements for Cryptographic Modules. Other suitable encryption methods may be used.

The user data stored in the smart card 1 includes an identification code or number for identifying a user to whom the smart card 1 is issued. In one embodiment, the identification code or number is a username, which conforms to a variation of a person's name, e.g., “john.doe.” In one embodiment, additional information about the user may be included in the user data. In one embodiment, the user data further includes the identification code or number of the card also known as a card ID.

Referring to FIGS. 1 and 2, an embodiment of a setup process for the system is described. The setup creates a user profile for a user authorized to use the MFP 3 and issues a smart card to the user. In one embodiment, the administrator uses a special setup program that is designed to create user profiles. In one embodiment, the setup program may be executed in the authenticating device 5. In the alternative, the administrator may run the setup process at another computer or computing device.

In step S1 of FIG. 2, a system administrator creates a new user profile and adds a name of a user (i.e., the username) to the user profile. Although not limited thereto, typically the administrator performs this step by typing in a new username with a keyboard or keypad (not shown) either connected or attached to the authenticating device 5. In one embodiment, the administrator obtains the username from the authorized user prior to creating the user profile. In the alternative, the username can be assigned by the administrator or the setup program.

In step S2, the administrator adds a password for the user to the user profile. The password can be configured to have any suitable length and variation of numbers or alphanumeric characters. As in step S1, the password can be input using a keyboard or keypad. In one embodiment, the administrator obtains the password from the authorized user prior to creating the user profile. In the alternative, the administrator or setup program may assign a temporary password to the user profile. The temporary password can be changed later by the user. In one embodiment, in addition to the password, the administrator may input additional information to the user profile to enhance the security of the system. The additional information may be biometric information such as one or more of a voice recording, a fingerprint, an iris pattern image, etc., corresponding to the authorized user.

Next in step S3, the administrator adds to the user profile any device privilege or restriction applicable to the user. A device privilege or restriction (collectively “privilege”) refers to information that identifies particular devices and functions of the devices that the authorized user is permitted or restricted to use. In one embodiment, the privilege information of a user's user profile may specify one or more office machines that the user can access among many office machines. In such situation, the user can be authorized to use only those machines the privilege information specifies and cannot access the other office machines. Further, the privilege information may specify particular functions of an office machine for which the user is authorized access. For instance, the privilege information may specify that the user is authorized to use the printing function of the MFP 3 and is not authorized to use the fax function of the same machine.

Subsequently in step S4, the setup program stores the user profile in a data storage accessible by the authenticating device 5. In the illustrated embodiment, the authenticating device 5 has a data storage such as a memory where the user profiles are stored. In an alternative embodiment, the user profiles may be stored in a memory of the computer where the setup program is run. Then, the user profiles are transferred to a memory to which the authenticating device 5 can access during the operation of the system after the setup.

In an embodiment, as shown in step S5, the administrator issues to the user a smart card containing the username that has been entered to the respective user profile. In issuing the smart card, the administrator may use a smart card writer connected to the computer which runs the setup program. In one embodiment, the setup program is run in the authenticating device, which is provided with a smart card writer. In one embodiment, the username is stored in the memory of the smart card in an encrypted form. In one embodiment, the setup program comprises an encryption module, which encrypts the username. Then, the encrypted username is transferred to the smart card writer, and is written in the memory of the smart card. The smart card is then issued to the new user. Optionally, the smart card may also contain other data, such as a unique identification code or number associated with the smart card (i.e., a card ID).

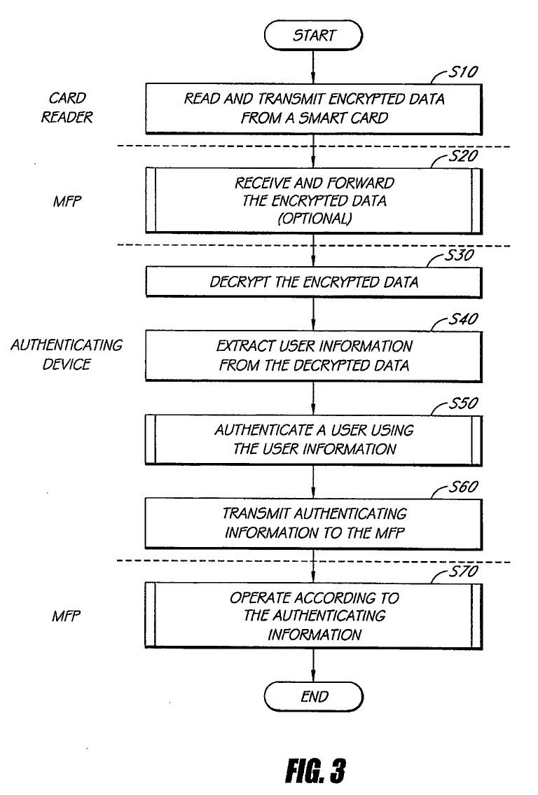

Now referring to FIGS. 1 and 3, an embodiment of limiting access to the MFP is described. When a user wishes to use the MFP 3 for certain operations, the user is required to, for example, insert or swipe a smart card into a slot of the card reader 2 for reading. In other embodiments, the user could have biometric information read into the system to identify and authenticate the user. In another embodiment, both the portable memory device and biometric information may be input. In step 10, the card reader 2 reads user data from the smart card 1. In the embodiment, the user data is encrypted and read in the encrypted form. As discussed, the encrypted user data include a username of the user to whom the smart card 1 has been issued. In one embodiment, the user data may include a card ID in an encrypted form. The card reader 2 then transmits the encrypted data to the MFP 3 without decryption. The data transmission from the reader 2 to the MFP 3 is shown as dashed arrow 11 in FIG. 1.

Subsequently, in step S20, the MFP 3 receives and forwards the encrypted user data to the authenticating device 5 (dashed arrows 12 and 13, FIG. 1). In the embodiment where the card reader 2 is directly connected to the network 4 or the authenticating device 5, the step S20 can be omitted, and therefore the user data is transmitted to the authenticating device 5 without going through the MFP 3.

Optionally, although not shown, the MFP 3 or card reader 2 may receive security input data from a user to enhance the security of the system. The security input data is forwarded to the authenticating device 5 along with the encrypted user data. The security input data, as noted above, is generally biometric information The MFP 3 or card reader 2 includes an input device to receive the security input data according to the type of the security input. The security input data may be encrypted before being transmitted to the authenticating device 5. The encryption method used for the security input data may be different from that used for the user data.

Next, in step S30, the authenticating device 5 receives and decrypts the encrypted data. The decryption is conducted using a counterpart decryption method of the encryption method used for user data encryption. Further, in an embodiment where the security input data made by the user is encrypted, the encrypted security input data is also decrypted as well.

In step S40, the authenticating device 5 processes the decrypted data to identify and extract information from the decrypted data. In one embodiment, the user information includes username and/or card ID originating from the smart card 1. In another embodiment, the user information further includes the security input data made by the user at the MFP 3 or the card reader 2.

In step 50, the authenticating device 5 begins processing to determine whether the user identified by the user information is authorized to access the MFP 3. This process will result in creating user authenticating information which indicates approval or denial of the access to the MFP 3. In one embodiment, the authenticating information may further include information relating to privilege of the user in using the MFP 3 in which case the user is granted selective access to the MFP 3. The process of authentication will be discussed in detail with reference to an additional flowchart.

Subsequently, in step S60, the authenticating information is transmitted to the MFP 3 which receives the authenticating information. The dashed arrows 14 and 15 of FIG. 1 represent this transmission of data to MFP 3. Next, in step S70, the MFP 4 operates according to the authenticating information. For example, if the authenticating information indicates “access approval,” the MFP 3 processes the request from the user. Further, if the authenticating information includes certain privilege information, the MFP 3 processes the user request pursuant to such information. On the other hand, if the authenticating information indicates “access denial,” the MFP 3 does not process the user's request.

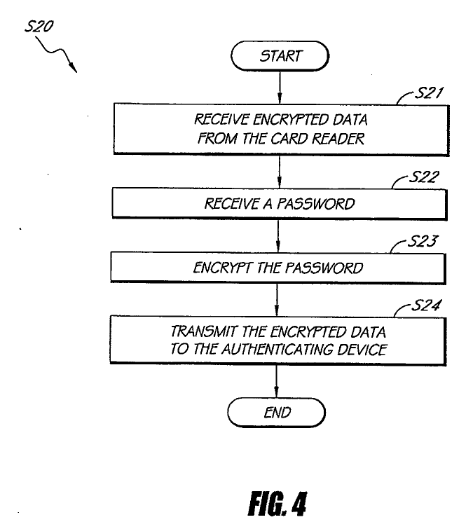

FIG. 4 illustrates a process of the step of receiving and forwarding encrypted data S20 of FIG. 3 according to an embodiment. As noted in FIG. 3, this process is optional and may be omitted in some embodiments. First, in step S21, the MFP 3 receives the encrypted data from the card reader 2. In step S22, the user inputs his/her password as security input data at the card reader 2 or the MFP 3. In step S23, the MFP 3 encrypts the password. In embodiments, the encryption method can be identical or different from the one used to encrypt the user data stored in the smart card 1. Subsequently, the encrypted data from the card reader 2 and encrypted password are transmitted to the authenticating device 5 in step S24. In the embodiments where the password is encrypted, the authenticating device 5 will decrypt and extract the password before the authenticating step S50 of FIG. 3. In another embodiment, the steps S22 and S23 can be omitted. In another embodiment, the steps S22 and 25 can be performed before the step S21.

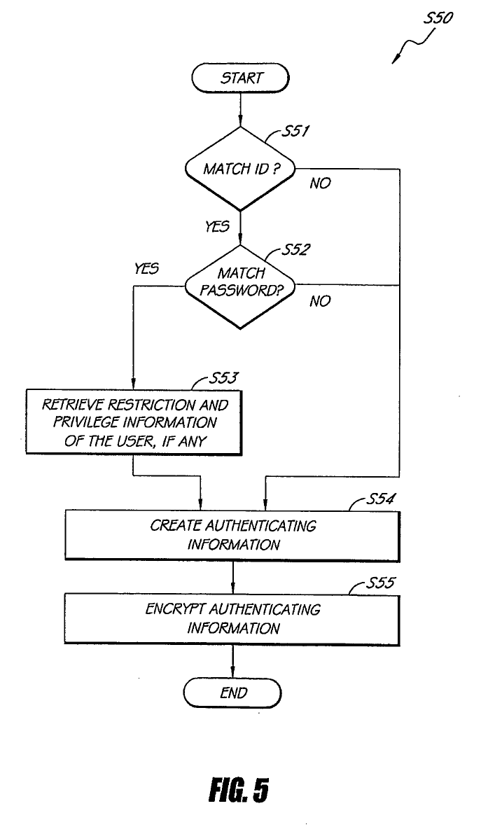

FIG. 5 illustrates a process of the step S50 (FIG. 3) authenticating a user using the user information which is performed by the authenticating device 5. First, in step S51, the authenticating device 5 locates in its memory a user profile that corresponds to the user information. In one embodiment, the authenticating device 5 compares a username originating from the smart card 1 with each of usernames stored in the memory of the authenticating device 5. It determines whether the username from the smart card 1 matches any username stored in the memory of the authenticating device 5.

If a matching username is located, it is then determined whether the password input by the user matches that stored in the memory of the authenticating device. First, if a matching username is located, the authenticating device retrieves from its memory a user profile associated with the matching username. Next, it extracts a password that is stored in the user profile. The authenticating device then compares the password from the user with that stored in the user profile.

If the password matches, privilege information in conjunction with the user is retrieved from the user's profile in step S53. Based on the results of the steps S51, S52, and S53, the authenticating device creates authenticating information in step S54. If the username and password match those stored in a user profile, the authenticating device 5 creates authenticating information that indicates approval of access by the user to the MFP 3. If the user profile includes any privilege information, the authenticating information includes such information as well. However, if any of the username and password fails to match an authorized user's profile information, authenticating information will include an indication of access denial in step S54.

Subsequently, in step S55, the authenticating information is encrypted. In one embodiment, the authenticating information is encrypted with an encryption scheme or code different from that of the user data stored in the smart card 1. In one embodiment, the encryption of authenticating information is in the same format of the encryption of the password. This last step S55 is, however, optional and can be omitted in certain embodiments.

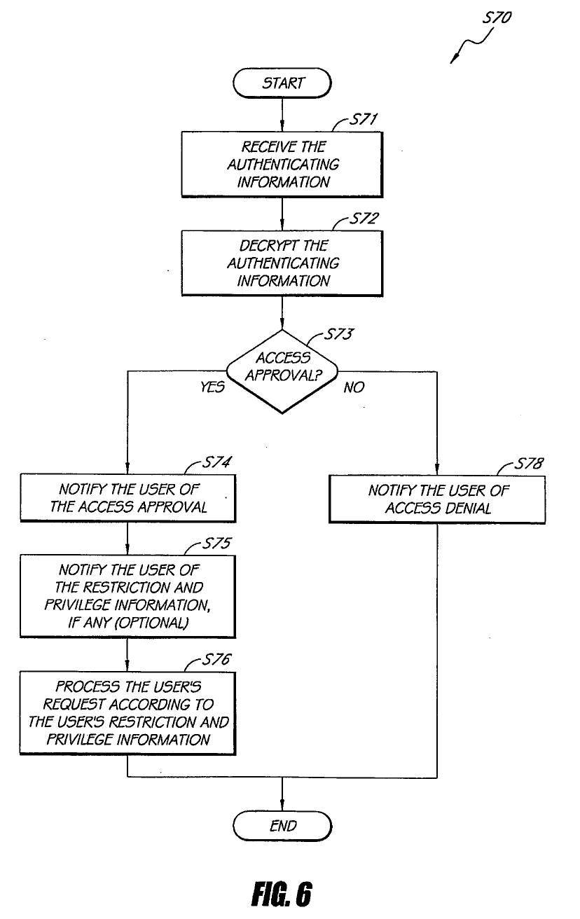

FIG. 6 illustrates an embodiment of the process for operating an MFP according to the authenticating information in step S70 of FIG. 3. First, in step S71, the MFP 3 receives the authenticating information from the authenticating device 5. Next, in step S72, the MFP 3 decrypts the authenticating information if it has been encrypted in step 55 in FIG. 5. If the authenticating information indicates access approval in step S73, the MFP 3 notifies the user that the access to the MFP 3 is approved. Typically, the access approval information is presented on a display, although embodiments are not necessarily so limited to this approach. Subsequently, the user may be also notified of any privilege information associated in using the MFP 3 in step S75. This notification of privilege, however, can be omitted in some embodiments. Finally, the user's request is processed according to any applicable user's privileges of the user. However, if the access of the user to the MFP 3 is denied in step S73, the user is notified of access denial and the MFP 3 does not process the user's request. It should be noted that granting of device access approval and operation privileges may be processed together in one operation.

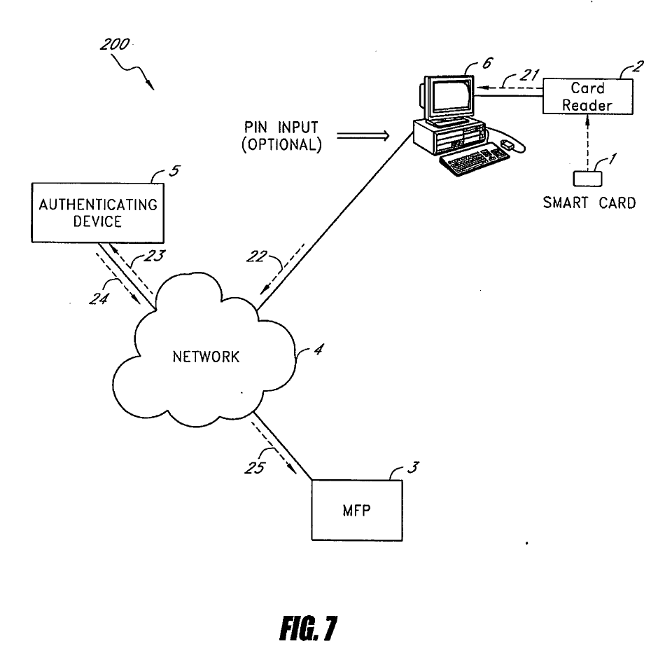

FIG. 7 illustrates another embodiment of a system 200 for limiting access to a shared office machine according to another embodiment. Illustrated are a card reader 2, a personal computer (PC) 6, a network 4, an MFP 3, and an authenticating device 5. The card reader 2 is connected to the PC 6 in FIG. 7 whereas a card reader is directly connected to an MFP in FIG. 1. The card reader 2 is connected to the PC 6 using, for example, a USB connection. Alternatively, in another embodiment, the keyboard of the PC 6 may include a card reader device. In that case, a separate card reader is not required. Yet in another embodiment, a portable memory device that can be plugged into a USB port is used instead of the smart card. In that case, a USB port of the PC 6 is substituted for the card reader 2.

The descriptions made with reference to the system 100 are generally applicable to the system 200. The card reader 2 reads from the smart card 1 the encrypted user data, including the username. Next, the card reader 2 transmits the data to the PC 6. This data transmission is shown as dashed arrow 21 in FIG. 7. The PC 6 then transmits the encrypted data to the authenticating device 5 over the network 4 (dashed arrows 22 and 23). Additionally, the PC may receive security input data such as a password, and transmit it to the authenticating device 5 as well. Next, the authenticating device 5 conducts an authenticating process and transmits the resulting authenticating information to the MFP 3 (dashed arrows 24 and 25). The MFP 3 operates according to the authenticating information transmitted from the authenticating device 5.

The system 200 and the method described above are particularly suitable for the printer function of the MFP 3. A printer user generally needs to access a printer while working with a PC. This is because the user generally creates and transmits a printing instruction in the PC that the user is using. By having a card reader connected to the PC, the PC user does not have to move to the location of the MFP 3.

Although not illustrated, in another embodiment, the card reader 2 can be directly connected to the network 4. In this embodiment, the card reader 2 may need a network interface module for the direct connection with the network. Then, the card reader directly transmits encrypted user data read from a smart card to the authenticating device via the network 4. All the other configurations remain the same as the systems 100, 200 illustrated in FIGS. 1 and 7. The foregoing description is that of embodiments of the invention and various changes, modifications, combinations and sub-combinations may be made without departing from the spirit and scope of the invention, as defined by the appended claims.

What is claimed is:

1. A system for limiting access to a multi-function printer, comprising:
a portable memory device storing user data;
a reader configured to read the user data from the portable memory device;
an authenticating device in data communication with the reader, the authenticating device configured to receive the user data from the reader and to authenticate a user based on the user data, thereby creating authenticating information; and
a multi-function printer (MFP) in data communication with the authenticating device via a network, the multi-function printer configured to receive the authenticating information from the authenticating device and to provide selective access to operations according to the authenticating information.

2. The system of claim 1, wherein the MFP is connected to the reader, and wherein the MFP is configured to receive the user data from the reader and to transmit the user data to the authenticating device.

3. The system of claim 2, wherein the user data is encrypted and wherein the MFP receives and transmits the encrypted user data intact.

4. The system of claim 1 wherein the reader is in data communication with the authenticating device via a computer.

5. The system of claim 1, wherein the reader is connected to the authenticating device via a network.

6. The system of claim 1, wherein the portable memory device comprises a smart card.

7. The system of claim 1, wherein the MFP functions comprise a printer, a scanner, a photocopier, and a facsimile machine.

8. The system of claim 1, wherein the authenticating device comprises a computer configured to execute user authenticating software.

9. The system of claim 1, wherein the user data is encrypted.

10. The system of claim 1, wherein the authenticating device comprises a data storage configured to store a user profile for each one of a plurality of users.

11. The system of claim 10, wherein the authenticating device is configured to authenticate the user based on the user data and the user profile.

12. The system of claim 10, wherein the user profile comprises at least one of access restriction and privilege of the user.

13. The system of claim 2, wherein the MFP is configured to receive a password from the user and to transmit the password to the authenticating device.

14. The system of claim 13, wherein the MFP is configured to encrypt the password received from the user, and wherein the authenticating device is configured to decrypt the encrypted password before authenticating the user.

15. A system for limiting access to a multi-function printer comprising:
means for storing user data;
means for receiving the user data from the means for storing user data;
authenticating means for determining whether a user identified with the user data is authorized for a requested operation, thereby creating authenticating information indicative of the determination; and
means for multi-function operation, the multi-function operation means processing the requested operation according to the authenticating information.

16. The system of claim 15, wherein the means for storing user data is accessible using a USB port of a computer, and wherein the means for receiving the user data comprises a computer having a USB port.

17. A method of providing selective access to a multi-function peripheral device comprising:
reading user data from a portable memory device;
transmitting the user data to an authenticating device;
determining whether a user identified by the user data is authorized to use the multi-function peripheral device, thereby creating authenticating information; and
transmitting the authenticating information to the peripheral device so that each functional operation of the multi-function peripheral device can be selectively accessed according to the authenticating information.

18. The method of claim 17, wherein the user data is transmitted to the authenticating device via the peripheral device or a computer.

19. The method of claim 17, wherein the user data is transmitted to the authenticating device via a network.

20. The method of claim 17, wherein the authenticating information includes at least one of access restriction and privilege of the user.

21. The method of claim 17, wherein the user data is stored encrypted in the portable memory device, and wherein the encrypted user data is decrypted before determining whether the user identified by the user data is authorized to use a peripheral device.

22. The method of claim 17, further comprising:
receiving a password from a user; and
transmitting the password to the authenticating device.

23. The method of claim 22, further comprising:
encrypting the password prior to transmitting the password to the authenticating device;
decrypting the encrypted password prior to determining; and
using the password in determining.

24. The method of claim 17, further comprising operating the peripheral device according to the selective access provided to the user.

25. The method of claim 24, further comprising:
encrypting the authenticating information prior to transmitting to the peripheral device; and
decrypting the authenticating information subsequent to transmitting the authenticating information to the peripheral device.
